(19) United States
(12) Patent Application Publication
(10) Pub. No.: US 2005/0162991 A1
(43) Pub. Date: Jul. 28, 2005

(54) Optical information storage device and optical information storage system

(75) Inventor: Michio Matsuura, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/082,593

(22) Filed: Mar. 17, 2005

Related U.S. Application Data
(63) Continuation of application No. PCT/JP03/04218, filed on Apr. 2, 2003.

(51) Int. Cl. G11B 7/085

(52) U.S. Cl. 369/30.27

(57) ABSTRACT

The present invention provides an optical information storage device having a large storage capacity and an optical information storage system in which the device size is compact, the capacity is expanded, and the maintenance is improved. Within a blade housing, there are provided a medium storage section storing plural optical storage media, a recording/reproducing section recording and/or reproducing the information on and/or from the optical storage medium, a medium movement section moving the optical storage medium between the medium storage section and the recording/reproducing section, which are arranged in one row and integrally held, and a connection section removably connecting the device to a system housing.

### TECHNICAL FIELD

The present invention relates to an optical information storage device that records and reproduces the information on and from an optical storage medium in which at least the information is optically reproduced, and an optical information storage system in which plural optical information storage devices are integrated.

### BACKGROUND ART

It is expected that the amount of data including the transaction information or home page data transmitted on a communication network represented by the Internet or the like will explosively increase in the near future in the light of rapid developments of the information communications industry in recent years. Also, due to the virus problems or increasing crimes on the communication network, we are sometimes obliged to do logging in the Internet. Given such situations and foreseeable future, a larger capacity of the information storage device is strongly demanded. However, as a hard disk that is a kind of mass information storage capable of reading and writing data at high speed requires high cost for additional installation, the information beyond a capacity of the hard disk is now inevitably discarded. Also, a magnetic tape storage unit that is a kind of mass information storage has a larger capacity than the hard disk at low cost, but the magnetic tape, which is the sequential medium reading and writing sequentially the information, has slow input/output speed of the information, and thus is only employed for the purpose of storing the information for long term.

To cope with an explosive increase in the data amount that is expected in the near future, it is insufficient to simply store a large amount of data. Thus, it is desired to consistently store the information amount of peta-bytes and make the fast access (so-called near-line access) within a few seconds to secure a high degree of retrieval in various fields such as a data mining field of finding a trend of consumption from a great amount of information such as sales information, an experimental data analysis field related with the atomic physics, a collation technique field using the fingerprint or DNA information, a patent information retrieval field, a bank/securities field, an electronic clinical chart field, and an IDC (Internet Data Center) field. The hard disk may now be only practical technique to cope with such a demand, but the hard disk has the following drawbacks.

The hard disk has the drawbacks of needing high cost when making additional installation for more capacity as described above, as well as high exchange cost when the medium has a failure. It also requires high power consumption because the medium having high inertia must be always rotated at high speed to monitor the increased error due to an instant head load or thermal fluctuation. As the apparatus failure is associated with data loss due to the use of a non-replaceable medium fixed within the device, reconstruction of data takes a long time after replacement of the apparatus at the time of apparatus failure, causing a risk of temporal degradation in the processing performance. In addition, as the redundancy of data maintenance is decreased during the data reconstruction, prolonged data reconstruction likely leads to system downs.

The optical information storage device that stores the information, employing the optical storage medium represented by MO or DVD, in contrast to the hard disk having those drawbacks, can read or write the information at high speed, and is expected to have remarkably larger capacity in the near future, or a storage capacity comparative to that of the magnetic tape storage device, due to technical renovations such as development of a blue laser diode and a surface recording system. Therefore, it is noted as the next generation storage device at high speed and with large capacity. While the magnetic tape is weak to wetting with water or contamination, and has a possibility that large amounts of stored data may disappear at the time of disaster, the optical storage medium is strong to wetting with water or contamination, and the storage life is as long as 50 to 100 years, while the optical information storage device has a high utility value as the next generation storage device for storage of long term data.

In the present situations, a technique that allows data to be recorded in plural optical storage media as if they were a single optical storage medium (e.g., refer to Japanese Patent Publication No. 7-93110), and a technique that allows plural optical storage media to be transferred collectively from the storage place to the drive and accessed at the same time to make the fast access and transfer of the information (e.g., refer to Japanese Patent Publication Nos. 7-320373, 8-249794 and 8-263924) have been already offered.

However, these conventionally offered techniques are singly-offered elementary techniques, and have some problems to make the device compact, to expand the capacity and enhance the maintenance in actually constructing an operable apparatus.

### DISCLOSURE OF THE INVENTION

In the light of the above-mentioned problems, it is an object of the present invention to provide an optical information storage device having a large storage capacity and an optical information storage system in which the device is compact, the capacity is expanded, and the maintenance is improved.

In order to accomplish the above object, the present invention provides an optical information storage system including:
plural optical information storage devices having a medium storage section that stores plural disk-like optical storage media capable of recording and reproducing the information, in which the information is reproduced at least optically, a recording/reproducing section that records and/or reproduces the information on and/or from the optical storage medium, a medium movement section that moves the optical storage medium between the medium storage section and the recording/reproducing section, and a blade housing that holds integrally the medium storage section, the medium movement section and the recording/reproducing section, in which the medium storage section, the medium movement section and the recording/reproducing section are internally arranged in one row;
a system housing that houses the plurality of optical information storage devices, and dismountably holds the plurality of optical information storage devices; and
an integration section that integrates recording and/or reproduction of the information in each of the plurality of optical information storage devices mounted within the system housing.

This optical information storage system of the present invention includes the plural optical information storage devices in which the medium storage section, the recording/reproducing section and the medium movement section are arranged compactly within the blade housing, and is constructed to have large capacity and compact size. Also, the capacity can be easily expanded by increasing the number of optical storage media or optical information storage devices, and the maintenance is facilitated by mounting or dismounting or replacing the medium storage section or optical information storage device.

In the optical information storage system of the present invention, it is preferable that the integration section distributes and stores the information in the plural optical information storage devices.

In the optical information storage system of this form, one information is distributed and stored at the same time in the plural optical information storage devices, or the distributed and stored information is reproduced at the same time, whereby the total information access rate can be increased.

Also, in the optical information storage system of the present invention, it is more preferable that the integration section distributes and stores the information in the plural optical information storage devices, and records the redundant information in one or more optical information storage devices among the plural optical information storage devices, and when there is missing information while reproducing the distributed and stored information, the information is restored based on the redundant information.

In this way, preparation for the redundant information is to contribute to not only increased security of data, but also to enhanced throughput by restoring data of a defective portion with the redundant information and saving a trouble of rereading, when a local read error occurs due to trash. In this invention, the expandability and maintenance ability are improved by employing the replaceable media, but if these replaceable media are employed, the trash may possibly remain on the media, likely causing a local read error. Since the rotation rate of the optical storage medium is lower than that of the hard disk, the throughput is greatly lowered when data is reread. Therefore, in this invention, the redundant information plays important role in increasing the throughput.

Also, in the optical information storage system of the invention, it is preferable that the integration section manages, as a reserve, at least one of the plural optical information storage devices, and in the event of failure of the optical information storage devices other than the reserve optical information storage device, the reserve optical information storage device is employed instead of the failed optical information storage device.

With the optical information storage system of this form, even when the optical information storage device fails, the reserve optical information storage device is substituted to continue the overall system operation. Thereby, the unmanned operation for long time is allowed.

Moreover, it is also preferable that the optical information storage system of the present invention further includes a transmission path transmitting the input or output information into or from the optical storage medium of the optical information storage device, and a buffer temporarily saving the information between the recording/reproducing section of the optical information storage device and the transmission path, and inputting or outputting the information at a higher rate than the transmission rate of the information through the transmission path.

With the optical information storage system of this form, a time lag caused by replacement of the optical storage medium in the recording/reproducing section of the optical information storage device can be absorbed by the buffer at the time of input and output, and hidden as seen from outside of the system.

Also, the present invention provides an optical information storage device that records or reproduces the information on or from a disk-like optical storage medium capable of recording and reproducing the information, in which the information is reproduced at least optically, including:
a medium storage section that stores the plural optical storage media;
a recording/reproducing section that records and/or reproduces the information on and/or from the optical storage medium;
a medium movement section that moves the optical storage medium between the medium storage section and the recording/reproducing section;
a blade housing that holds integrally the medium storage section, the medium movement section and the recording/reproducing section, in which the medium storage section, the medium movement section and the recording/reproducing section are internally arranged in one row; and
a connection section that dismountably connects the optical information storage device to a system housing mounted with the plural optical information storage devices.

With the optical information storage device of the present invention, the medium storage section, the recording/reproducing section and the medium movement section are arranged compactly within the blade housing, whereby the capacity is easily expanded by increasing the number of optical storage media or arranging plural optical information storage devices, and the maintenance is easily made by mounting or dismounting or replacing the medium storage section or optical storage medium disposed at one end within the blade housing.

In the optical information storage device of the present invention, it is preferable that the optical storage medium can store the information on both sides, and the recording/reproducing section further includes plural optical heads that apply light onto both sides of the optical storage medium at the same time, and a movement mechanism that moves an illumination position, at which light is applied by the plural optical heads, on each of the tracks not crossing each other as seen from a direction vertical to both sides of the storage medium.

A so-called double-sided recording type medium is employed as the optical storage medium to make access to both sides at the same time, whereby the storage capacity and the access speed are increased while avoiding an increased volume. However, such plural optical heads has a malfunction if one illuminating light impinges on the other side. Thus, the movement mechanism that moves the illumination position on each of the tracks not crossing each other is provided to avoid the malfunction.

Also, in the optical information storage device of the present invention, it is preferable that the recording/reproducing section rotates the optical storage medium to record and/or reproduce the information on and/or from the optical storage medium being rotated at a steady rotational frequency, and completes a predetermined preparation required for the recording and/or reproducing operation after starting the rotation of the optical storage medium and before the rotation reaching the steady rotational frequency.

To enable the recording/reproducing section to record and/or reproduce the information on and/or from the optical storage medium, it is necessary to make the focusing for the focal point of light applied on the optical storage medium, the tracking to keep the relative distance constant between the tracks provided spirally or concentrically on the optical storage medium and the illumination position of light, and the reading of the logical address indicating the position in the storage area, marked in the storage area of the optical storage medium, as the preparation for recording and/or production. Also, to normally record and/or reproduce the information, it is necessary that the optical storage medium be laid on the recording/reproducing section and rotated at the steady rotation number. By completing the above preparation before the recording/reproducing section reaches the steady rotation number, the inaccessible time zone that may arise at the time of replacing the optical storage medium can be reduced.

Moreover, in the optical information storage device of the invention, it is preferable that the optical storage medium can store the information on both sides, and has a predetermined normal rotation direction, and the recording/reproducing section detects the normal rotation direction of the optical storage medium, and rotates the optical storage medium in the detected normal rotation direction to record and reproduce the information on and from the optical storage medium being rotated.

In the case of the device that accesses the optical storage medium capable of storing the information only on one side by rotating it, it is necessary to rotate the optical storage medium only in the predetermined rotation direction at any time to access it. Since it is possible to clearly distinguish between the recorded face and unrecorded face of the medium by visual means or the like, an error in which the medium is laid inside out is unlikely to occur, though such an error has not been coped with. Also, in the case of the device in which the optical storage medium capable of storing the information on both sides is accessed for every side, the medium is turned over in changing the accessed face, whereby if the optical storage medium is rotated in the predetermined rotation direction at any time and accessed, it is possible to make access to both sides of the medium.

However, in the case of the device in which the optical storage medium capable of storing the information on both sides is accessed on both sides at the same time, if the medium is rotated only in the predetermined rotation direction at any time, both sides of the medium are inaccessible when the medium is laid inside out on the device. To increase the number of storing the medium, it is desirable that the disk-like medium is directly stored in the medium storage section. In this form, an error that the optical storage medium is stored inside out may possibly occur.

Thus, by adopting the constitution in which the normal rotation direction is detected and the medium is rotated in the normal rotation direction, it is possible to cope with an error in which the medium is stored inside out.

In the form of detecting the normal rotation direction, there are types in which the optical storage medium has the predetermined information stored at a predetermined position, and the recording/reproducing section detects the normal rotation direction by attempting to read the predetermined information at the predetermined position of the optical storage medium, the optical storage medium is provided with a recording film where the information is recorded, a predetermined portion of the recording film being formed in an asymmetrical shape relative to the reverse of the rotation direction, and the recording/reproducing section detects the normal rotation direction by referring to the shape in the predetermined portion of the recording film, the optical storage medium has a magnet embedded therein whose magnetic poles are different on both sides of the optical storage medium, and the recording/reproducing section detects the normal rotation direction by referring to the magnetic poles of the magnet, and the optical storage medium is provided with a recording film where the information is recorded, a predetermined portion of the optical storage medium being different in the state of the recording film provided between both sides, and the recording/reproducing section detects the normal rotation direction by referring to the state of the recording film in the predetermined portion. Any of the above types may be employed in the present invention.

Moreover, in the optical information storage device of the invention, it is preferable that the optical storage medium includes an IC storing the inherent information that distinguishes each optical storage medium, and the medium movement section includes a reader reading the inherent information stored in the IC of each optical storage medium.

With the optical information storage device of this form, the inherent information of the optical storage medium is checked without employing the recording/reproducing section, whereby it is possible to confirm in advance the next access object while accessing the optical storage medium, or promptly confirm the optical storage medium within the medium storage section at the time of replacing the medium.

Also, in the optical information storage device of the present invention, it is preferable that the optical storage medium is marked with a logical address in a storage area of each optical storage medium, the logical address indicating a logical position in the storage area to be consecutive over plural optical storage media, the medium storage section includes a storage element that stores the storage information indicating the correspondence between the storing position and the logical address of each optical storage medium, the optical information storage device has an address control section that finds the optical storage medium having the storage area marked with the same logical address as the specified logical address, based on the stored information of the storage element, if the logical address is specified, and instructs it to the medium movement section, and the medium movement section loads the optical storage medium instructed by the address control section into the recording/reproducing section.

With the optical information storage device of this form, the logical address of each optical storage medium stored in the medium storage section is known by referring to the stored information stored in the storage element, whereby it is possible to start to access the medium rapidly, when the medium storage section is replaced, for example. Also, since the logical address is assigned consecutively over plural media, the plural media can be accessed in the same way as one medium having large capacity with consecutive logical addresses assigned from outside of the optical information storage device.

In such optical information storage device of the form in which the storage element is provided in the medium storage section, it is desirable that the address control section checks the storing position of each optical storage medium stored in the medium storage section, and updates the storage information of the storage element, when the optical storage medium loaded into the recording/reproducing section has no storage area marked with the same logical address as the specified logical address.

The optical storage medium within the medium storage section may be changed in the stored position, when it is removed from the optical information storage device to make the maintenance, in which if wrong stored information is directly employed, the information destruction may be caused. Thus, it is desirable to prevent the information destruction by updating the storage information.

Also, in the optical information storage device of the form in which the storage element is provided in the medium storage section, it is desirable to have an access path which directly accesses the storage element from outside of the blade housing, bypassing the address control section.

By having this access path, it is possible to check the storage information from outside, employing the access path, to know the logical address and the like, even when the power of the optical information storage device is turned off.

### BRIEF DESCRIPTION OF THE DRAWINGS

FIG. 1 is an external view of an optical information storage system and an optical information storage device according to one embodiment of the present invention;

FIG. 2 is a view showing the details of a magazine;

FIG. 3 is a view showing an optical disk;

FIG. 4 is a partial enlarged view of the optical disk;

FIG. 5 is a conceptual illustration showing the shape of track on the optical disk;

FIG. 6 is a view showing the hardware structure of a blade;

FIG. 7 is a functional block diagram showing the functional structure of the blade;

FIG. 8 is a functional block diagram showing the functional structure of a system MO;

FIG. 9 is a graph showing the data accumulation amount of buffer when recording the information;

FIG. 10 is a graph showing the data accumulation amount of buffer when reproducing the information;

FIG. 11 is a diagram showing the hardware structure of a drive;

FIG. 12 is a view showing the movement of a carriage;

FIG. 13 is a flowchart showing a logical address assigning operation;

FIG. 14 is a timing chart showing a preparatory operation for a drive;

FIG. 15 is a diagram showing a principle on a method of detecting the normal rotation direction in a second example of the optical disk;

FIG. 16 is a view showing a third example of the optical disk;

FIG. 17 is a conceptual diagram showing the data processing for distributed storage;

FIG. 18 is a diagram showing the data flow within a integrated system at the time of distributing and storing data;

FIG. 19 is a flowchart showing a blade control operation when recording the information; and

FIG. 20 is a flowchart showing the blade control operation when reproducing the information.

### BEST MODE FOR CARRYING OUT THE INVENTION

The preferred embodiments of the present invention will be described below. In the following description, “information” and “data” may sometimes be employed without distinction.

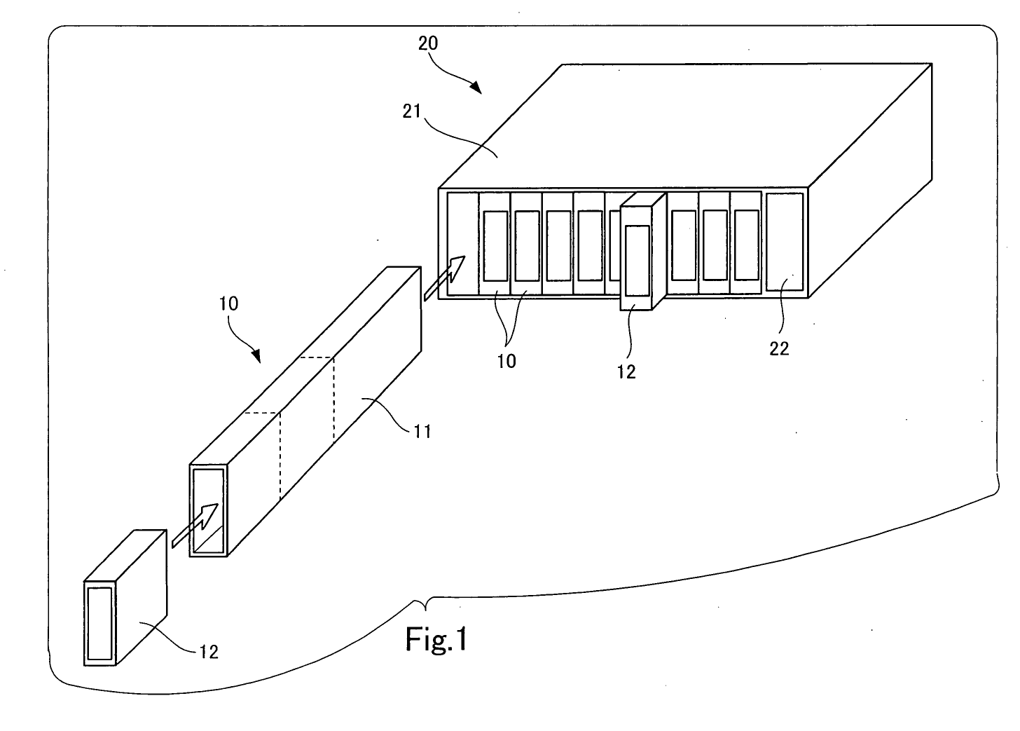

FIG. 1 is an external view of an optical information storage system and an optical information storage device according to one embodiment of the present invention.

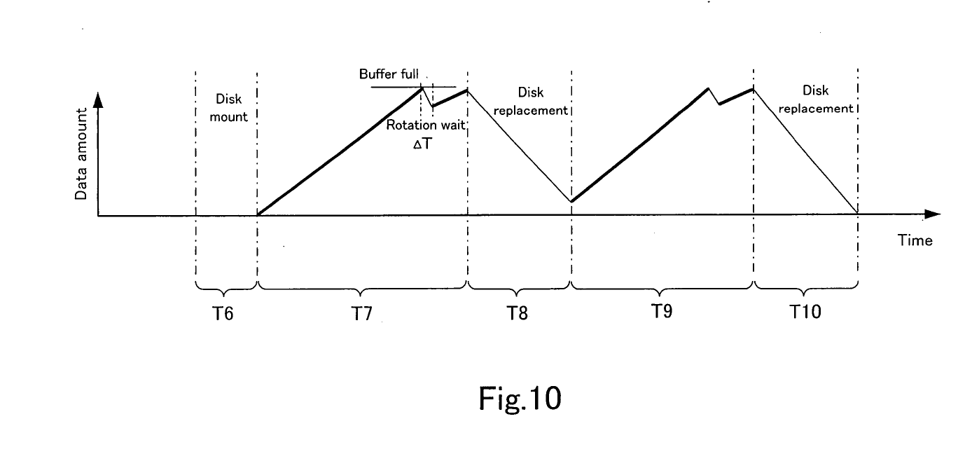

FIG. 10 shows a blade unit 10 using an optical magnetic (MO) disk as one example of the optical storage medium and corresponding to the optical information storage device according to one embodiment of the present invention and an integrated system 20 incorporating plural (10 in this figure) blade units 10 and corresponding to the optical information storage system according to one embodiment of the present invention.

A housing 11 of the blade unit 10 has a length of triple or more the diameter of the MO disk, a width (height in this figure) slightly more than the diameter of the MO disk, and a thickness (width in this figure) much smaller than the diameter of the MO disk, in which a magazine 12 storing plural MO disks is removably disposed at one end of this housing 11.

A housing 21 of the integrated system 20 is mounted with plural blade units 10 to be freely inserted or extracted, and the magazine 12 of each blade unit 10 can be removed even in a state where the blade unit 10 is inserted into the housing 21 of the integrated system 20. Also, the integrated system 20 has a control unit 22 for integrating the recording and reproduction of the information in each of the plural blade units 10.

Such integrated system 20 houses the plural blade units 10 within the housing 21 to make a mass storage system of compact. Also, the capacity is easily expanded by increasing the number of MO disks or blade units 10, and the maintenance is easily made by mounting or dismounting or replacing the magazine 12 or the blade unit 10.

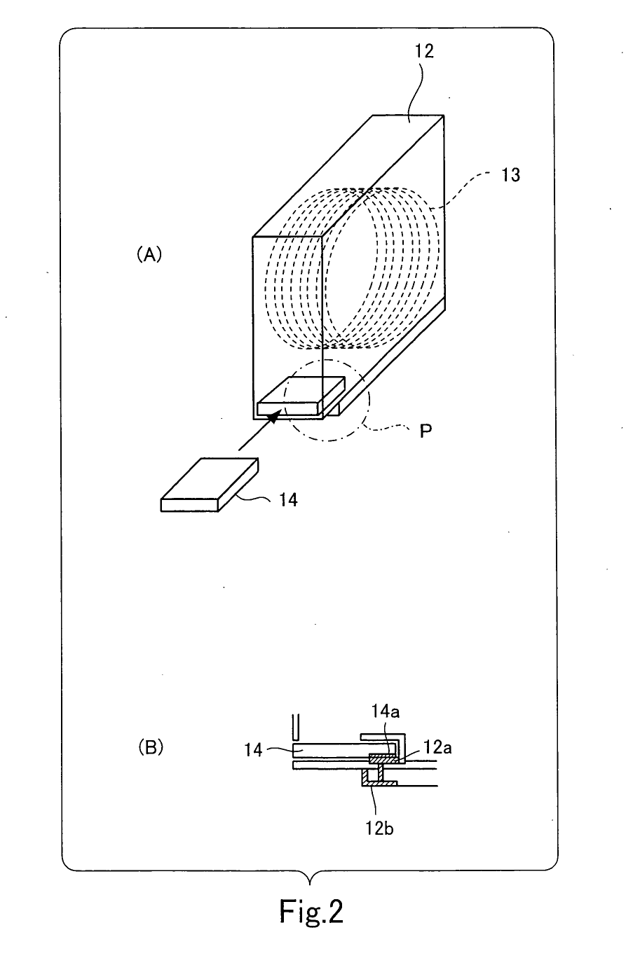

FIG. 2 is a view showing the details of the magazine.

Part (A) of FIG. 2 shows a perspective view showing a state where the plural MO disks 13 are stored within the magazine 12, and part (B) of FIG. 2 is an enlarged cross-sectional view of a range P encircled by the one-dot chain line.

A storage area storing the information is provided on each MO disk 13 in a unit called a sector, and each sector has the structure as listed in Table 1 below.

TABLE 1

| | |
|---|---|
| Header section | Data section |

| | | |
|---|---|---|
| Physical address | Logical address | User data |

Each sector has a header section where the permanent information is written by pits or wobbles in producing the MO disk 13 and a data section where data can be rewritten optically or magnetically, in which the information in the header section includes the physical address indicating the physical position of each sector on the MO disk 13. Also, the data section has a logical address indicating the logical position of each sector to be consecutive over the plural MO disks 13 within the magazine 12, and the essential user data to be stored in each sector.

A demountable FRAM 14 corresponding to one example of the storage element as used in the present invention is inserted into the magazine 12, and a terminal 14a of the FRAM 14 is in contact with an internal terminal 12a provided in the magazine 12, and electrically connected with an external terminal 12b connected to the internal terminal 12a. This external terminal 12b is electrically connected with an internal wiring of the blade unit 10, when the magazine 12 is attached on the blade unit 10 as shown in FIG. 1, whereby the FRAM 14 is ready for reading or writing by the blade unit 10.

The FRAM 14 records the storage position of each MO disk 13 within the magazine 12 and a range of logical address allocated to each MO disk 13 in the format as listed in Table 2 below.

TABLE 2

| Storage position | Range of logical address | Medium number |
|---|---|---|
| 1 | 4000-5FFF | 1234 |
| 2 | 0000-1FFF | 5678 |
| 3 | 2000-3FFF | 2222 |
| . | . | . |
| . | . | . |
| . | . | . |
| 8 | A000-BFFF | 8765 |

Data as shown in Table 2 corresponds to one example of the stored information as used in the present invention, and referred to by the blade unit 10 when accessing the information of the MO disk 13 within the magazine 12. In an example of Table 2, eight MO disks 13 stored at eight storage positions are assigned to eight ranges of logical addresses, in which the storage sequence of the MO disks 13 is different from the logical address sequence. Also, in the example of Table 2, the medium number inherent to each MO disk is recorded. Employing the allocated logical address, the storage areas of plural MO disks 13 are managed as the storage area on one medium.

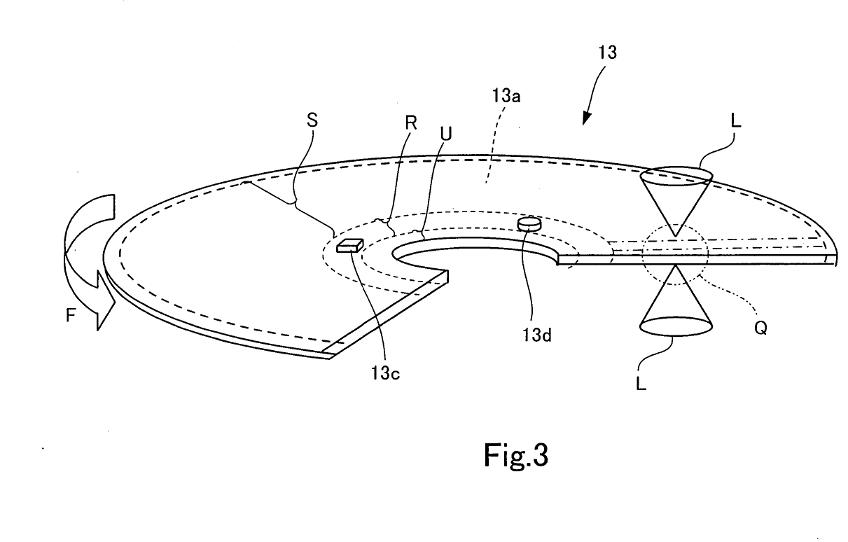

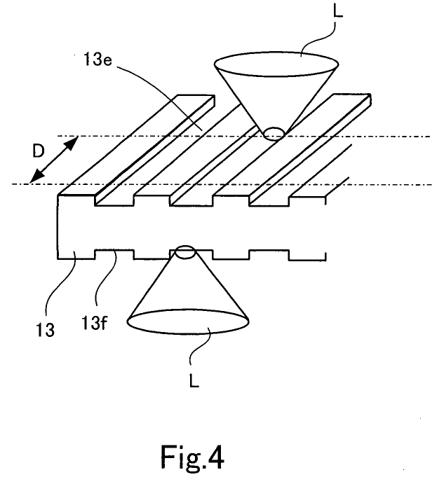

FIG. 3 is a view showing the structure of the MO disk, and FIG. 4 is an enlarged view for a part Q in FIG. 3.

In the present embodiment, the MO disk 13 is of the type in which the information can be recorded on both sides, and a recording film 13a is provided in a recording area S of this MO disk 13 on each of the front and back sides. The recording film 13a on each of the front and back sides is irradiated with light L respectively for each of the front and back sides to record or reproduce the information.

A clamp area U on the innermost side of the MO disk 13 is an area to be held at the time of loading the MO disk into a drive which will be described later. An intermediate area R between the recording area S and the clamp area S has an IC 13c and a magnet embedded therein. The IC 13c stores the inherent information such as the medium number to discriminate the MO disk 13 from each other and the magnet 13d has a different magnetic pole between both sides.

The MO disk 13 in the present embodiment has a normal rotation direction, as indicated by the arrow F, and is accessed in a state where the MO disk 13 is rotated in the normal rotation direction as indicated by the arrow F when gaining access to any of the front and back faces. The magnet 13d embedded into the intermediate area R is employed to determine the normal rotation direction.

On the front and back faces of the MO disk 13, the spiral tracks 13e, 13f are provided. In the present embodiment, light L is applied on the tracks 13e, 13f. Also, light L for the front and back faces is moved on the tracks by a distance D from each other, as will be detailed later.

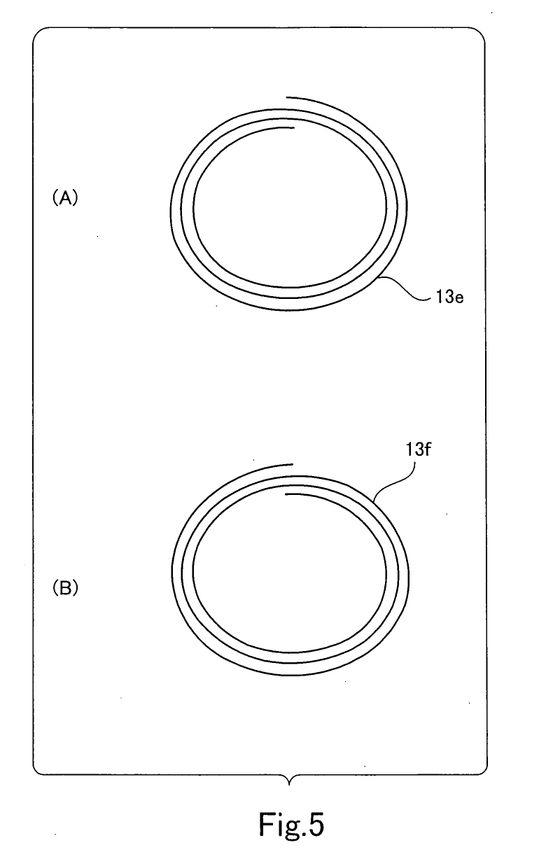

FIG. 5 is a conceptual illustration showing the shape of track on the MO disk.

Part (A) of FIG. 5 shows a track 13e provided on the surface of the MO disk, in which the track 13e has a spiral shape of being wound clockwise.

On the other hand, part (B) of FIG. 5 shows a track 13f provided on the back face of the MO disk, in which the track 13f has a spiral shape of being wound counterclockwise.

Accordingly, if the MO disk rotating in the normal rotation direction as indicated by the arrow F in FIG. 3 is accessed, the information is recorded or reproduced sequentially from the outer circumference to inner circumference of the MO disk on bode sides, whereby the MO disk is easily controlled when accessed on the front and back sides at the same time.

The MO disk 13 as shown in FIG. 3 stores the definite information required for accessing the MO disk 13, such as defective sector address and medium capacity, at the predetermined position in the recording area S, in which this definite information can be only read out when the MO disk 13 is rotated in the normal rotation direction, but can not be read when reversely rotated.

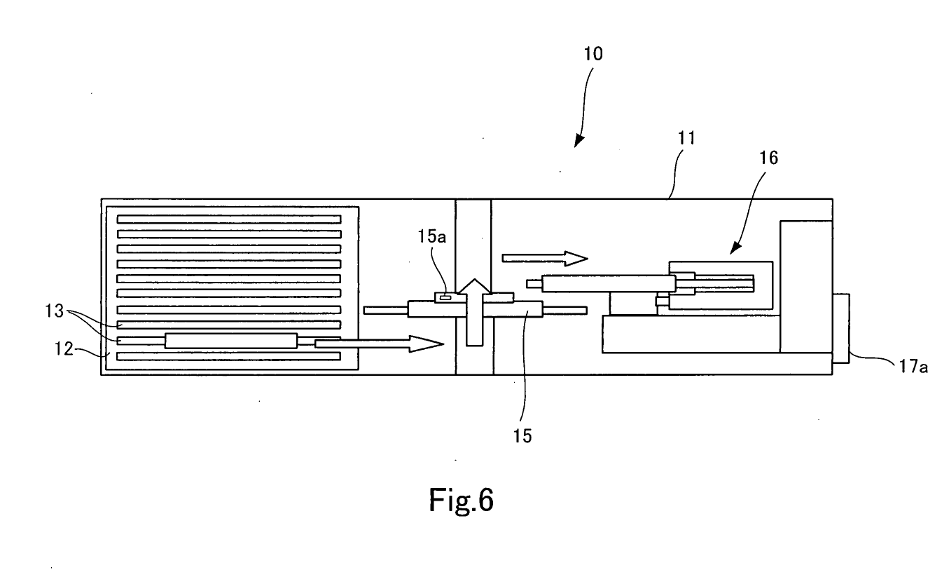

FIG. 6 is a view showing the hardware structure of the blade unit.

The blade unit 10 as shown in FIG. 1 has the magazine 12 and the drive 16 that records and reproduces the information on and from the MO disk 13 within the housing 11, and a changer 15 moving the MO disk 13 between the magazine 12 and the drive 16. The drive 16 corresponds to one example of the recording/reproducing section in the present invention, and the changer 15 corresponds to one example of the medium movement section in the present invention.

In this way, the blade unit 10 receives the magazine 12, the changer 15 and the drive 16 within the housing 11 compactly, and the storage capacity can be easily expanded by increasing the number of MO disks 13 as long as there is any empty space within the magazine 12. Also, the maintenance is easily made by dismounting or replacing the magazine 12 or the MO disk 13.

At one end of the blade unit 10 opposite to the magazine 12, a connector 17a for an interface transferring the data between the blade unit 10 and the outside is provided. If the blade unit 10 is inserted into the housing 21 of the integrated system 20 as shown in FIG. 1, this connector 17a is joined with a connector of the integrated system 20. This connector 17a corresponds to one example of a connection part in the present invention.

The changer 15 has a function of inserting or extracting the MO disk 13 into or from the magazine 12, a function of moving the MO disk 13 vertically in the figure, and a function of loading or unloading the MO disk 13 into or from the drive 16. Also, the changer 15 has an IC sensor 15a reading out the information stored in the IC embedded into the MO disk 13, making it possible to check the inherent information of the MO disk 13 without employing the drive 16. Therefore, it is possible to confirm the next access object during the access to one MO disk 13, and confirm the MO disk 13 within the magazine 12 rapidly when replacing the magazine 12.

As described with reference to FIG. 1, the housing 11 in the present embodiment has a length of triple or more the diameter of the MO disk 13, but the changer 15 and the drive 16 can be disposed so that the MO disk 13 on the changer 15 and the MO disk 13 loaded into the drive 16 overlap each other. The length of the blade housing as used in the present invention is preferably 2.5 times or more the diameter of the optical storage medium.

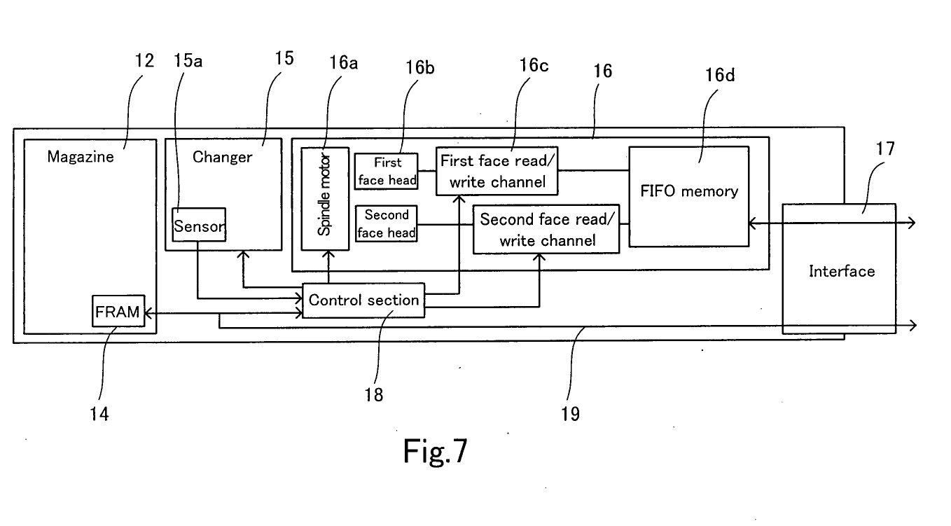

FIG. 7 is a functional block diagram showing the functional structure of the blade.

The blade unit 10 has the magazine 12, the changer 15 and the drive 16, as described above, and further has a control section 18 controlling the changer 15 and the drive 16 and an interface 17 transferring the data between the blade unit 10 and the outside. This interface 17 is one selected from among the well-known high speed serial interfaces such as IEEE1394, USB and serial ATA, and not described in detail here.

The drive 16 has a spindle motor 16a holding and rotating the MO disk, and a head 16b recording and reproducing the information by applying light onto the MO disk, in which two heads 16b are provided on the first face (front face) and the second face (back face). Also, the drive 16 has a read/write channel 16c for the first face and the second face, and a first-in first-out (FIFO) memory 16d serving as the buffer.

If the logical address is specified from outside of the device via the interface 17 through a path, which is omitted here, the control section 18 tries to find an MO disk having the sector with the same logical address as the specified logical address, based on the stored information of the FRAM 14 within the magazine 12, and instructs the changer 15 to move the identified MO disk. The changer 15 takes the MO disk specified by the control section 18 out of the magazine 12, and loads it into the drive 16. As the control section 18 can find the MO disk to be accessed, based on the stored information of the FRAM 14, the MO disk can be quickly accessed even when the magazine 12 is replaced.

Also, if the control section 18 finds that the MO disk loaded into the drive 16 has no sector with the same logical address as the specified logical address, through access by the drive 16 or reading the inherent information by the IC sensor 15a, it reconfirms the storage position of each MO disk stored within the magazine 12 using the drive 16 or the IC sensor 15a, and updates the stored information of the FRAM 14. In the MO disk within the magazine 12, the storage position may be possibly changed, when the magazine 12 is removed from the blade unit 10 for maintenance. Using the wrong stored information as it is may cause data destruction, but data destruction can be prevented by the function of updating the stored information.

The blade unit 10 is provided with an access path 19 which enables direct access to the FRAM 14 from outside of the blade unit 10 bypassing the control section 18. Consequently even when the power of the blade unit 10 is turned off, the stored information of the FRAM 14 can be confirmed via the access path 19 from the outside.

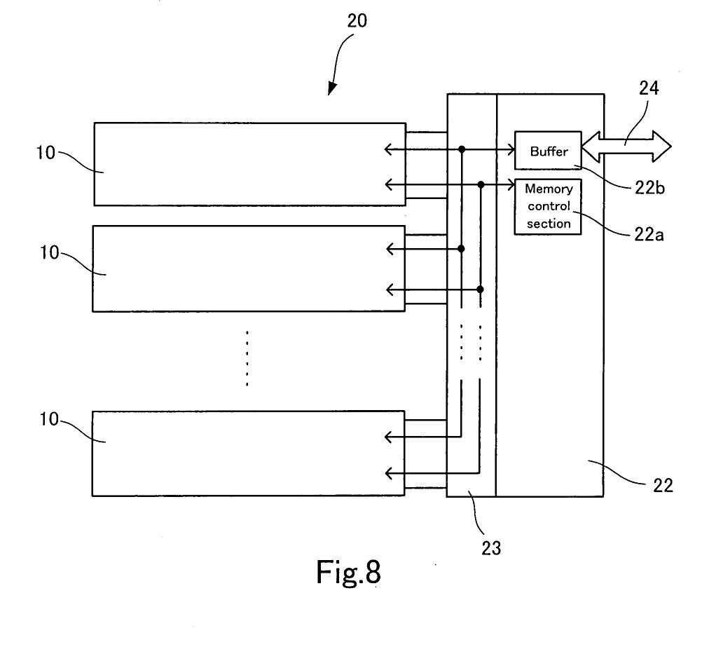

FIG. 8 is a functional block diagram showing the functional structure of the integrated system.

The integrated system 20 has the plural blade units 10 mounted therein, which are connected via the interface of each blade unit 10 to a data input/output unit 23 capable of making the high speed electric switching. Switching operation of the data input/output unit 23 is controlled by the control unit 22, as shown in FIG. 1. The control unit 22 accesses the FRAM 14 provided in the magazine of each blade unit 10 by a memory control section 22a to confirm the stored information, and controls the switching based on its stored information. Also, the control unit 22 is connected to an upper-level interface 24 that handles the data input/output with an upper-level system such as a server, and has a buffer memory 22b to synchronize the data input/output with the upper-level system.

This buffer memory 22b or the FIFO memory of each blade unit 10 corresponds to one example of the buffer as used in the present invention, the interface of the blade unit 10 for the FIFO memory, and the upper-level interface 24 for the data input/output unit 23 and the buffer memory 22b correspond to one example of the transmission path as used in the present invention, in which these buffers have the higher data input/output rate than the data transmission rate (maximum speed) through the transmission path on the upstream side thereof. Therefore, it appears that the continuous data input/output is performed, by hiding a time lag of data input/output associated with the medium exchange or the seek operation occurring within the system or device, as seen from the upper-level side of the transmission path, as described below.

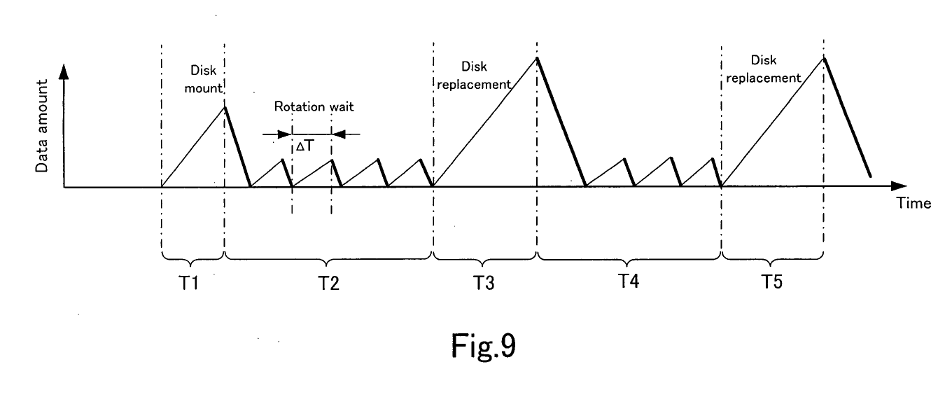

FIG. 9 is a graph showing the data accumulation amount of buffer when recording the information, and FIG. 10 is a graph showing the data accumulation amount of buffer when reproducing the information.

In these graphs, the transverse axis represents the time, and the longitudinal axis represents the data accumulation amount.

In recording the information, the MO disk of recording object is firstly loaded into the drive in a first time region T1, and the data sent from the upper-level system is accumulated in the buffer.

Then, data is written in the MO disk in a second time region T2, so that the data accumulated in the buffer is decreased. If the buffer becomes empty, writing is suspended for a predetermined latency time ΔT and data is accumulated in the buffer. Then, writing is resumed. Accordingly, the data accumulation amount in the buffer is basically zero at any time in the second time region T2.

Thereafter, in a third time region T3 the MO disk of recording object is exchanged and data is accumulated in the buffer. In a fourth time region T4, like the second time region T2, data is recorded. And in a fifth time region T5, like the third time region T3, the MO disk is exchanged. By repeating this procedure, the recorded data is entered from the upper-level system into the buffer without break.

In reproducing the information, the MO disk of reproduction object is firstly loaded into the drive in a sixth time region T6, when the buffer is empty because the reproduction is disabled.

Then, data of the MO disk is reproduced and accumulated in the buffer in a seventh time region T7. If the buffer becomes full, reproduction is suspended for the predetermined latency time ΔT, and data in the buffer is decreased. Then, reproduction is resumed. Accordingly, the data accumulation amount in the buffer is basically full at any time in the seventh time region T7.

Thereafter, in an eighth time region T8 the MO disk of reproduction object is exchanged and data flows out of the buffer. In a ninth time region T9, like the seventh time region T7, data is reproduced. And in a tenth time region T10, like the eighth time region T8, the MO disk is exchanged. By repeating this procedure, the recorded data is outputted from the buffer to the upper-level system without break.

In this way, the time lag is hidden as seen from the upper-level system at the time of data recording and data reproduction.

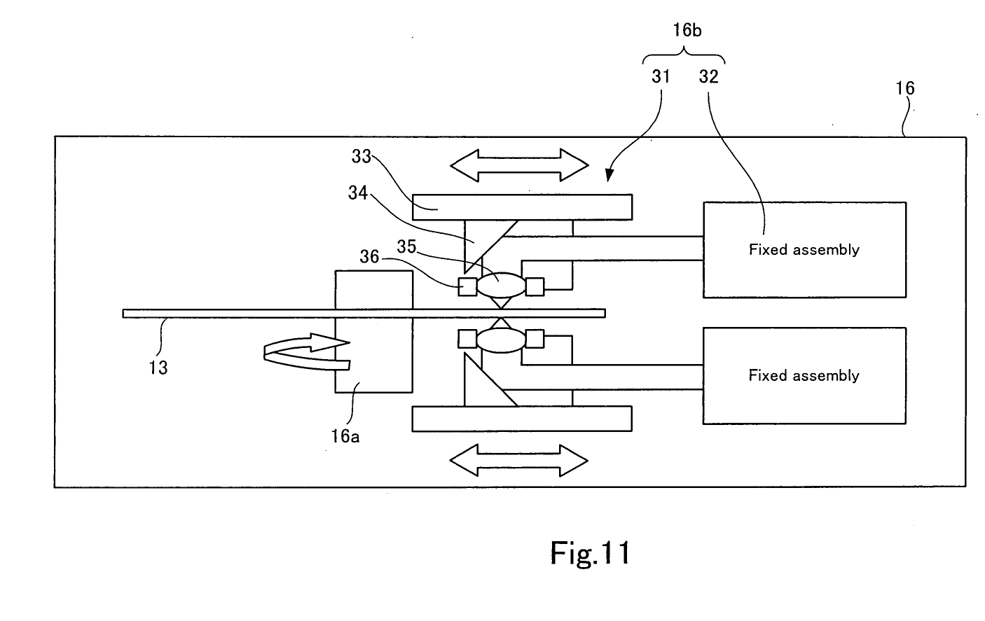

FIG. 11 is a diagram showing the structure near the head of the drive.

The drive 10 has two heads 16b. In FIG. 11, the structure near two heads 16b is illustrated. The two heads 16b are disposed on both sides of the MO disk 13 held and rotated by a spindle motor 16a. Each head 16b contains various kinds of optical elements, such as a laser diode and a photo detector, and have a fixed assembly 32 generating a laser beam for recording and reproduction and detecting the reproduced data, and a movable assembly (carriage) 31 which applies the laser beam to a desired position of the MO disk 13 while moving on a predetermined rail and returning the reflected light from the MO disk 13 to the fixed assembly 32. Moreover, the movable assembly (carriage) 31 has a carriage base 33, a rising mirror 34 reflecting the laser beam, a converging lens 35 converging the laser beam onto the MO disk 13, and a lens actuator 36 moving the converging lens 35.

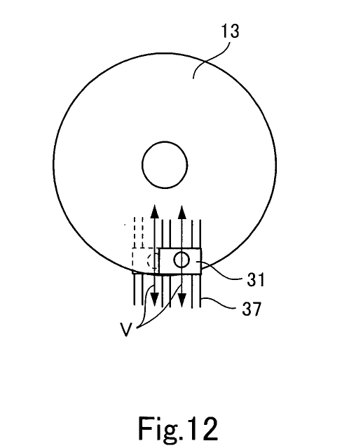

FIG. 12 is a view showing the movement of the carriage.

As described above, as the carriage 31 is moved on a rail 37, the converging position on the MO disk 13 to which light is converged by the carriage 31 moves on a track V.

The rails 37 for the carriages 31 of two heads are shifted in parallel to each other, as seen from a direction vertical to the plane of the MO disk 13, and the converging positions at which the carriages 31 converge the light are separated by a distance D from each other, as shown in FIG. 4. Thereby, even when light is applied onto the MO disk 13 by two heads at the same time, a malfunction can be prevented which is caused when one illuminating light impinges on the other side. The arrangement of the rails 37 may be not only in parallel to each other, as employed in an example of FIG. 12, but also radial from the center of the MO disk 13.

The drive records or reproduces the data on or from the MO disk 13, and records or reads the logical address as listed in Table 1 above. The logical address is assigned to each MO disk by performing a logical address assigning operation as will be described later, when the blade unit is initiated, when the MO disk within the magazine is replaced with the new MO disk, or when the new MO disk is added.

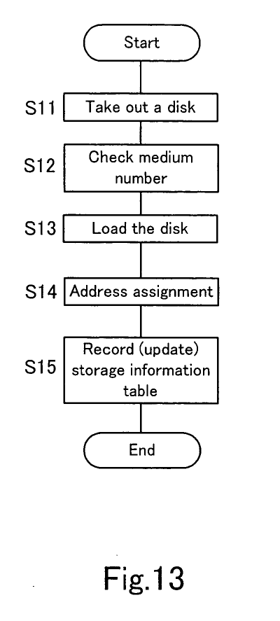

FIG. 13 is a flowchart showing the logical address assigning operation.

This logical address assigning operation starts every time the magazine is inserted into the blade unit. First, each disk is taken out (step S11), and the medium number contained in the inherent information stored in the IC of each disk is confirmed (step S12). If each medium number confirmed here is exactly matched with the medium number contained in the storage information stored in the FRAM as listed in Table 2 above, this logical address assigning operation ends here.

As a result of confirming the medium number (step S12), if there is any medium number different from that contained in the stored information, the MO disk having the medium number is loaded into the drive (step S13), a logical address range for the MO disk is decided, and the logical address is written at the top part of each sector (step S14). And the stored information is recorded or updated on the FRAM within the magazine (step S15), whereby the logical address assigning operation ends.

After the logical address is assigned in this way, the MO disk that the control section 18 of FIG. 7 specifies for the changer 15 is loaded into the drive 16 and recorded and reproduced, but it is necessary that the drive 16 performs a preparatory operation, which will be described below, before recording or reproducing it.

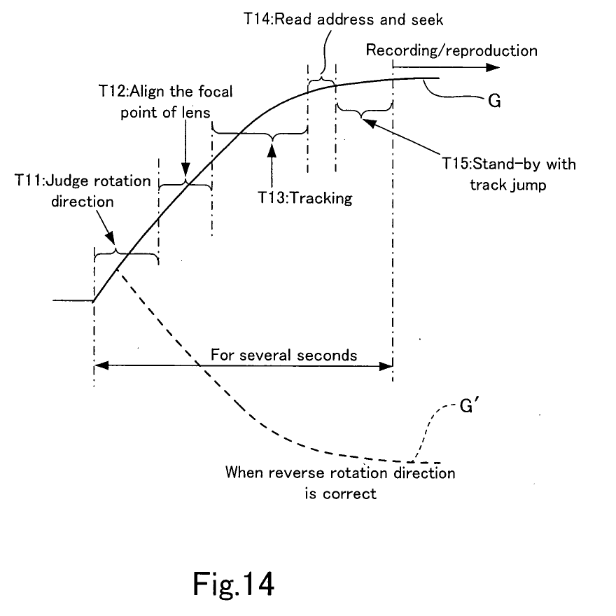

FIG. 14 is a timing chart showing a drive preparatory operation.

In FIG. 14, the transverse axis represents the time, and the longitudinal axis represents the rotational frequency of the MO disk.

If the MO disk is loaded into the drive, the MO disk starts to be rotationally driven by the spindle motor, whereby the rotational frequency is increased along with the passage of time, as represented by the curve G. In a time region T11 immediately after start of rotation, it is comprehensively judged whether or not the MO disk is rotated in the normal rotation direction as indicated by the arrow F of FIG. 3, by detecting the rotation direction by referring to the magnetic pole of the magnet 13d embedded into the MO disk as shown in FIG. 3, and by referring to the prescribed information such as the address of defective sector and the medium capacity. If the normal rotation direction is judged to be reverse, the rotation direction of the MO disk is reversed as represented by the curve G′. The MO disk capable of storing the information on both the front and back sides as used in the present embodiment is provided with the recording films on both the front and back sides, with a small difference in design between the front and back sides. Therefore, when the MO disk is taken out of the magazine for maintenance, there is high possibility that the MO disk is stored inside out in the magazine by mistake. Thus, by judging the normal rotation direction so as to rotate the medium in the normal rotation direction as described above, it is possible to deal with the case where the MO disk is stored inside out in the magazine.

Incidentally, in addition to the method of detecting the normal rotation direction using the magnet embedded into the MO disk in the example as shown here, another method may be considered and will be described below.

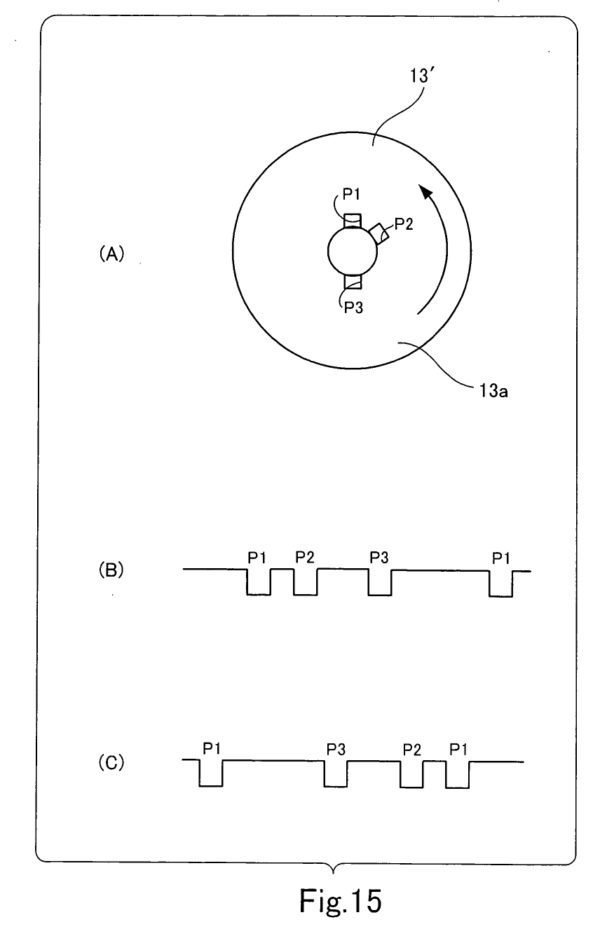

FIG. 15 is a principal diagram showing another method of detecting the normal rotation direction in a second example of the MO disk.

In the second example as shown here, the MO disk 13′ is provided with three notches P1, P2 and P3 on the recording film 13a, as shown in part (A) of FIG. 15, in which the three notches P1, P2 and P3 make up one example of “asymmetric shape by reversing the rotation direction” as used in the present invention. That is, the arrangement of the three notches P1, P2 and P3 becomes asymmetrical relative to the reverse of the rotation direction of the MO disk 13′, and if light is applied by moving the carriage where the notches P1, P2 and P3 are arranged, the pulse patterns of reflected light as shown in part (B) of FIG. 15 and part (C) of FIG. 15 occur. If the pattern in part (B) of FIG. 15 is assumed to be generated when the MO disk 13′ is rotated in the normal rotation direction, the pattern in part (C) of FIG. 15 is assumed to be generated when the MO disk 13′ is rotated in the reverse direction of the normal rotation direction. In this way, the normal rotation direction is detected by referring to the arrangement of the notches P1, P2 and P3 based on the pattern of reflected light.

The “asymmetric shape relative to the reverse of the rotation direction” as used in the present invention may be the shape in which the notches with different widths are arranged asymmetrically, for example.

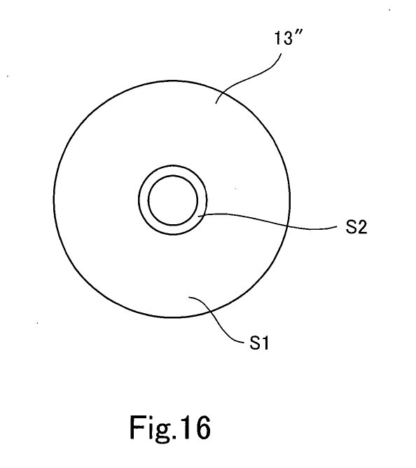

FIG. 16 is a view showing a third example of the MO disk.

In the third example as shown here, the MO disk 13″ is provided with the recording films on both the front and back sides in the area S1 corresponding to the storage area S in the MO disk 13 of the first example as shown in FIG. 3, and provided with the recording film on the single side in the area S2 inside the area S1. That is, the area S2 corresponds to one example of a portion “where the recording films are differently provided on the front and back sides” as used in the present invention.

In this way, since the recording film is provided on the single side in the area S2, when the carriage is moved to the area S2, a strong reflected light is produced on the side with the recording film because the focal point of light falls on the recording film, while the reflected light is greatly smaller on the side without the recording film because the recording film does not exist within the adjustment area of the focal point of light.

In this way, the front or back side of the MO disk 13″ is determined by referring to the state of the recording film based on the intensity of reflected light, thereby detecting the normal rotation direction.

Though in this third example, the recording film is provided only on the single side in the area S2, the portion “where the recording films are differently provided on the front and back sides” as used in the present invention also means that the recording film is provided all over the area S2 on one side, but may be provided like a stripe on the other side, for example.

Turning back to FIG. 14, the description for the example is further continued.

In the following, it is supposed that the initial rotation direction is coincident with the normal rotation direction.

In a time region T12 following the time region T11 for judgement of the rotation direction, the converging lens 35 is moved by the lens actuator 36 as shown in FIG. 11, so that the focal point of light converged by the converging lens 35 falls on the surface of the MO disk. Thereafter, this focused state is kept.

In the next time region T13, what is called a tracking is performed to control the focal point of light to follow the tracks 13e, 13f as shown in FIG. 4. In the next time region T14, the logical address of sector at the position which the focal point of light follows at present is read in, and the carriage is moved (does “seeking”) to the specified logical address.

Thereafter, in a time region T15 till the rotational frequency of the MO disk reaches the steady rotational frequency, a track jump is performed at every rotation of the MO disk, so that the MO disk turns in a standby state at the position of sector having the specified logical address. And if the rotational frequency of the MO disk reaches the steady rotational frequency, the recording and reproduction are started. In this way, the preparation for recording and reproduction is completed before the MO disk reaches the steady rotational frequency, whereby the inaccessible time zone occurring by exchanging the MO disk can be reduced.

Though the blade unit records and reproduces the information essentially in the same way as the storage device in which one MO disk is accessed, the integrated system having plural blade units to distribute and store the information has a higher access speed for the information.

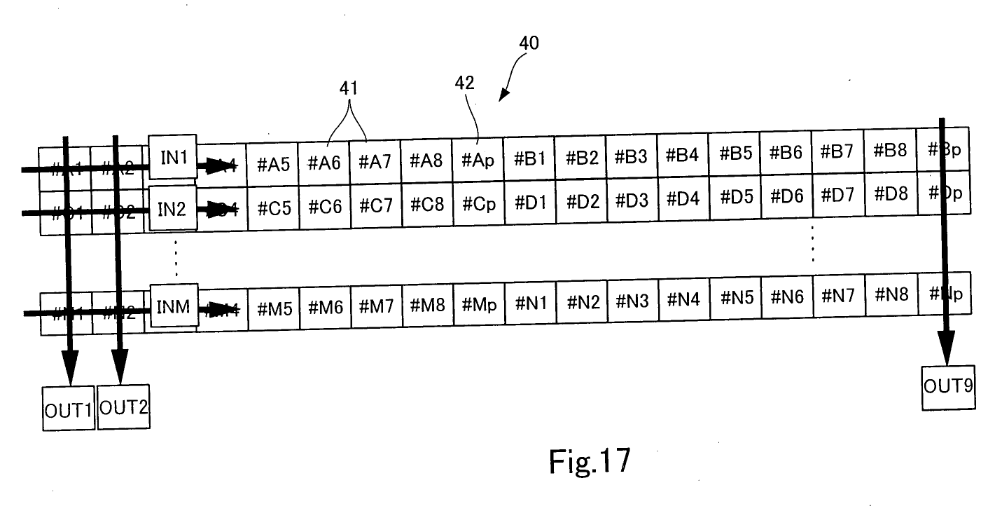

FIG. 17 is a conceptual diagram showing the data processing for distributed storage.

In FIG. 17, many unit data 41 sent from the upper-level system to the integrated system are illustrated, in which these data are sequentially sent from the upper-level system, as indicated by the arrow IN1, IN2, . . . , INM. And one parity data 42 is added to eight unit data 41 in the integrated system. Referring to the parity data 42, even if one of the eight unit data 41 is broken, it can be recovered.

In this way, eight unit data 41 and one parity data 42 are once stored in the buffer memory 22b as shown in FIG. 8, distributed from the buffer memory 22b over the FIFO memories of nine blade units, as indicated by the arrows OUT1, OUT2, . . . , OUT9, and recorded in each blade unit. That is, nine blade units handle respective works, such as storing only the first unit data among the eight unit data 41, and storing only the parity data 42. In this way, since data is distributed over the nine blade units, data recording or reproduction is performed in parallel and simultaneously in the nine blade units, whereby the total data input/output rate as the integrated system is increased. In contrast to the case where the input data is directly recorded on the MO disk according to input sequence, if the MO disk is damaged by trash, plural unit data 41 among the eight unit data 41 are broken at the same time, possibly leading to an unrecoverable condition by the parity data 42, when the input data is recorded according to the input sequence. On the other hand, when the data is distributed and recorded, the original data can be recovered, even if all the data for one blade unit disappears. That is, the security of data is remarkably enhanced by storing the distributed data.

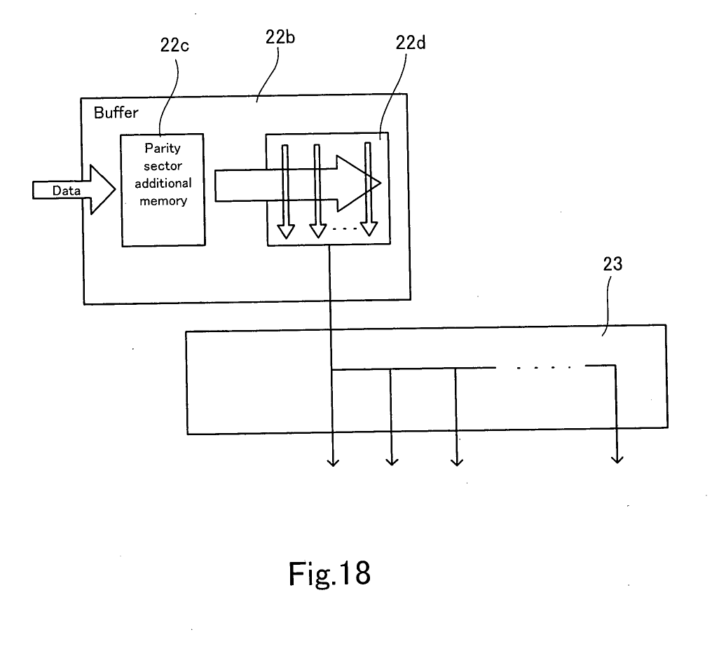

FIG. 18 is a diagram showing the data flow within the integrated system at the time of distributed storage.

In FIG. 18, the buffer memory 22b and the data input/output unit 23 are shown (also shown in FIG. 8) in which the buffer memory 22b has a parity addition memory 22c and a data matrix conversion memory 22d. The data sent from the upper-level system to the integrated system is entered into the parity addition memory 22c of the buffer memory 22b, in which the parity data is added from the parity addition memory 22c. Thereafter, the data is sent to the data matrix conversion memory 22d, and accumulated as a matrix of one row with nine columns which is composed of eight unit data 41 and one parity data 42. Each data of nine columns is sent via the data input/output unit 23 to the FIFO memories of nine blade units in the example of FIG. 17.

Though the information is distributed and stored in the nine blade units in the integrated system in this way, ten blade units 10 are mounted in the integrated system 20, and one blade unit not used for distributed storage is managed as a reserve device by the integrated system 20 in the present embodiment, as shown in FIG. 1. A control operation of the integrated system 20 managing the ten blade units 10 will be described below.

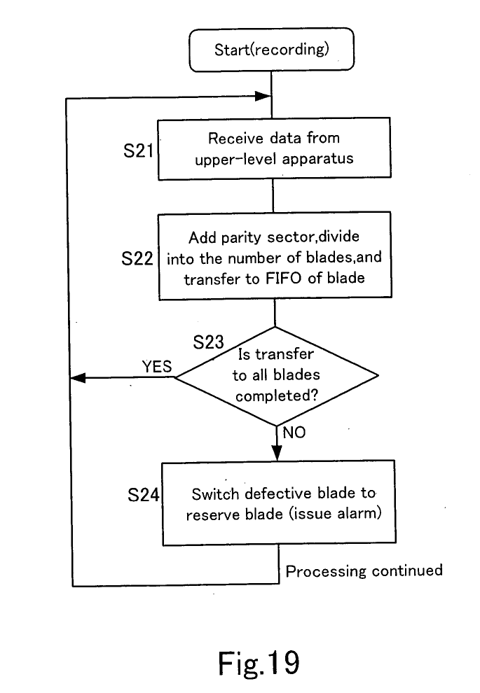

FIG. 19 is a flowchart showing a blade control operation when recording the information.

In recording the information, data is firstly received from the upper-level device (system) (step S21). Then, the parity data is added to the data, and the data is divided by the number of blades (nine here), and transferred to the FIFO memory of each blade unit (step S22). If the data transfer to the FIFO memory is normally completed for all the blade units (step S23: YES), the steps S21 and S22 are repeated.

On the other hand, if any blade unit fails in the data transfer to the FIFO memory (step S23: NO), the failed blade unit is regarded as a faulty blade unit, and switched to the reserve blade unit (step S24). At this time, an alarm indicating that the failure occurred is issued to the upper-level device (system). Thereafter, returning to the step S21, the above procedure is repeated.

In this way, in the integrated system with the reserve blade unit, the reserve blade unit is substituted, even when any blade unit fails, whereby the overall system operation can be continued. Thereby, unmanned operation for a long time is enabled.

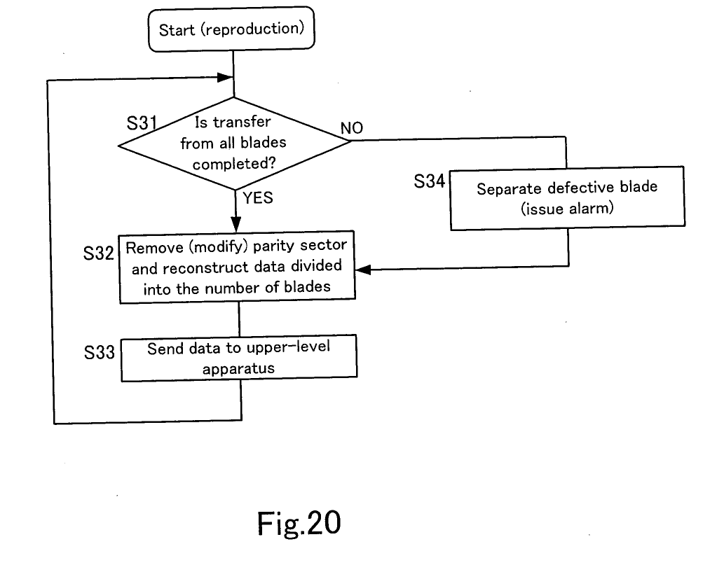

FIG. 20 is a flowchart showing the blade control operation when reproducing the information.

When reproducing the information, the data distributed and stored in each blade unit is firstly transferred to the buffer memory of the integrated system. If the transfer from all the blade units is normally completed (step S31: YES), the data check with parity data is made, whereby parity data is removed or data is recovered using the parity data to reconstruct the divided data in the original sequence (step S32). The reconstructed data is sent to the upper-level device (system) (step S33). Thereafter, returning to step S31, the information reproduction is continued.

On the other hand, in transferring data from each blade unit to the buffer memory of the integrated system, if any blade unit fails in the transfer (step S31: NO), the failed blade unit is regarded as a faulty blade unit, and separated (step S34). At this time, an alarm indicating that the failure occurred is issued to the upper-level device (system). Thereafter, the data recovery is made based on the data from the remaining normal blade units to reconstruct the data (step S32) and send the reconstructed data to the upper-level device (system) (step S33). Thereafter, returning to the step S31, the information reproduction is continued in the above way.

The description for the embodiments of the present invention is ended here.

Though in the above, the MO disk is employed as one example of the optical storage medium in the present invention, the optical storage medium in the present invention may be DVD or the like.

Though in the above, the FRAM is employed as one example of the storage element in the present invention, the storage element in the present invention may be IC memory or the like. Also, this storage element may be any one of commercially available storage elements or specially developed storage elements for use in the present invention.

Also, though in the above, one blade unit is employed as the reserve, the optical information storage system of the present invention may employ plural optical information storage devices as the reserve.

1. An optical information storage system comprising:
a plurality of optical information storage devices having a medium storage section that stores a plurality of disk-like optical storage media capable of recording and reproducing the information, in which the information is reproduced at least optically, a recording/reproducing section that records and/or reproduces the information on and/or from the optical storage medium, a medium movement section that moves the optical storage medium between the medium storage section and the recording/reproducing section, and a blade housing that holds integrally the medium storage section, the medium movement section and the recording/reproducing section, in which the medium storage section, the medium movement section and the recording/reproducing section are internally arranged in one row;
a system housing that houses the plurality of optical information storage devices, and dismountably holds the plurality of optical information storage devices; and
an integration section that integrates recording and/or reproduction of the information in each of the plurality of optical information storage devices mounted within the system housing.

2. The optical information storage system according to claim 1, wherein the integration section distributes and stores the information in the plurality of optical information storage devices.

3. The optical information storage system according to claim 1, wherein the integration section distributes and stores the information in the plurality of optical information storage devices, and records the redundant information in one or more optical information storage devices among the plurality of optical information storage devices, and when there is missing information while reproducing the distributed and stored information, the information is restored based on the redundant information.

4. The optical information storage system according to claim 1, wherein the integration section manages, as a reserve, at least one of the plurality of optical information storage devices, and in the event of failure of the optical information storage devices other than the reserve optical information storage device, the reserve optical information storage device is employed instead of the failed optical information storage device.

5. The optical information storage system according to claim 1, further comprising a transmission path transmitting the input or output information into or from the optical storage medium of the optical information storage device, and a buffer temporarily saving the information between the recording/reproducing section of the optical information storage device and the transmission path, and inputting or outputting the information at a higher rate than the transmission rate of the information through the transmission path.

6. An optical information storage device that records or reproduces the information on or from a disk-like optical storage medium capable of recording and reproducing the information, in which the information is reproduced at least optically, comprising:
a medium storage section that stores the plurality of optical storage media;
a recording/reproducing section that records and/or reproduces the information on and/or from the optical storage medium;
a medium movement section that moves the optical storage medium between the medium storage section and the recording/reproducing section;
a blade housing that holds integrally the medium storage section, the medium movement section and the recording/reproducing section, in which the medium storage section, the medium movement section and the recording/reproducing section are internally arranged in one row; and
a connection section that dismountably connects the optical information storage device to a system housing mounted with the plurality of optical information storage devices.

7. The optical information storage device according to claim 6, wherein the optical storage medium can store the information on both sides, and the recording/reproducing section further comprises:
a plurality of optical heads, for both sides of the optical storage medium, that apply light onto the optical storage medium; and
a movement mechanism that moves an illumination position, at which light is applied by the plurality of optical heads, on each of the tracks not crossing each other as seen from a direction vertical to both sides of the storage medium.

8. The optical information storage device according to claim 6, wherein the recording/reproducing section rotates the optical storage medium to record and reproduce the information on and from the optical storage medium being rotated at a steady rotational frequency, and completes a predetermined preparation required for the recording and reproducing operation, after starting the rotation of the optical storage medium and before the rotation reaching the steady rotational frequency.

9. The optical information storage device according to claim 6, wherein the optical storage medium can store the information on both sides, and has a predetermined normal rotation direction, and the recording/reproducing section detects the normal rotation direction of the optical storage medium, and rotates the optical storage medium in the detected normal rotation direction to record and reproduce the information on and from the optical storage medium being rotated.

10. The optical information storage device according to claim 9, wherein the optical storage medium has the predetermined information stored at a predetermined position, and the recording/reproducing section detects the normal rotation direction by attempting to read the predetermined information at the predetermined position of the optical storage medium.

11. The optical information storage device according to claim 9, wherein the optical storage medium is provided with a recording film where the information is recorded, a predetermined portion of the recording film being formed in an asymmetrical shape relative to the reverse of the rotation direction, and the recording/reproducing section detects the normal rotation direction by referring to the shape in the predetermined portion of the recording film.

12. The optical information storage device according to claim 9, wherein the optical storage medium has a magnet embedded therein whose magnetic poles are different on both sides of the optical storage medium, and the recording/reproducing section detects the normal rotation direction by referring to the magnetic poles of the magnet.

13. The optical information storage device according to claim 9, wherein the optical storage medium is provided with a recording film where information is recorded, a predetermined portion of the optical storage medium being different in the state of the recording film provided between both sides, and the recording/reproducing section detects the normal rotation direction by referring to the state of the recording film in the predetermined portion.

14. The optical information storage device according to claim 6, wherein the optical storage medium comprises an IC storing the inherent information that distinguishes each optical storage medium, and the medium movement section comprises a reader which reads the inherent information stored in the IC of each optical storage medium.

15. The optical information storage device according to claim 6,
wherein the optical storage medium is marked with a logical address in a storage area of each optical storage medium, the logical address indicating a logical position in the storage area to be consecutive over plural optical storage media,
the medium storage section comprises a storage element that stores the storage information indicating the correspondence between the storing position and the logical address of each optical storage medium,
the optical information storage device has an address control section that finds an optical storage medium having a storage area marked with the same logical address as the specified logical address, based on the stored information of the storage element, if the logical address is specified, and that instructs the medium movement section of the optical storage medium, and
the medium movement section loads the optical storage medium instructed by the address control section into the recording/reproducing section.

16. The optical information storage device according to claim 15, wherein the address control section checks the storing position of each optical storage medium stored in the medium storage section, and updates the storage information of the storage element, when the optical storage medium loaded into the recording/reproducing section has no storage area marked with the same logical address as the specified logical address.

17. The optical information storage device according to claim 15, further comprising an access path which directly accesses the storage element from outside of the blade housing, bypassing the address control section.
